(19) United States
(12) Patent Application Publication
(10) Pub. No.: US 2009/0320338 A1
(43) Pub. Date: Dec. 31, 2009

(54) Bottle Back Label Burst

(76) Inventor: Fabienne Marie-Ange David, San Francisco, CA (US)

Correspondence Address: THE CLOROX COMPANY, P.O. BOX 24305, OAKLAND, CA, 94623-1305, US

(21) Appl. No.: 12/145,816

(22) Filed: Jun. 25, 2008

(51) Int. Cl. G09F 23/00; G09F 3/10

(52) U.S. Cl. 40/310; 215/12.2; 283/94; 215/228

(57) ABSTRACT

A label assembly has a front label and a rear label both affixed to a non-opaque bottle. The front label has a transparent portion and the rear label has an opaque portion, wherein the bottle facing side of the rear label has a solid colored border with a white interior portion. This border provides a burst to the transparent front label.

### BACKGROUND OF THE DISCLOSURE

1. Field of the Disclosure

The present invention relates labeling on packaging for clear bottled liquids that uses a border on the inside panel of the back label to provide a three-dimensional burst for the graphics on a transparent front label.

2. Description of Related Art

Consumer product companies have gone to great extremes to make their products stand out on the store shelves. One trend has been to provide transparent front labels on transparent bottles to enable consumers to easily identify with the color of the consumer product. When the product is also transparent or semi-transparent, the consumer can also visualize the inside panel of the back label.

U.S. Pat. No. 6,272,777 to Swenson discloses a bottle having a magnifying front surface that allows the inside surface of the back label to be easily read. U.S. Pat. No. 4,658,974 to Fujita et al. and U.S. Pat. App. 2003/0115781 to Boutilier disclose a back label that is uniformly tinted to provide color to the contents of the bottle. U.S. Pat. App. 2008/0034627 to Schnuckle and U.S. Pat. App. 2002/0050715 to Elpidi disclose a front framing label to observe a back element. U.S. Pat. No. 5,758,440 to Yudin discloses a bottle with a front label having a car windshield that is cut-out to reveal an on-coming car on the back windshield. U.S. Pat. No. 7,010,877 to Geary disclosed a front window with two viewing areas that allow viewing of two portions of the back label.

While these bottle and label combinations enable greater consumer interest in the product or in the back label, there has not been a corresponding solution to providing greater consumer interest in the front label. Many current front labels are mostly transparent to highlight the color and appearance of the product inside. However, this transparency results in the front label fading into the color of the product. What is needed is a label assembly that allows the consumer to easily identify the appearance of the product, while also providing a burst effect to the front label. This invention provides a dark-colored opaque burst outline from the back label to frame the mostly transparent front label.

### SUMMARY OF THE DISCLOSURE

To answer the shortcomings of the prior art, the present invention provides in one embodiment a bottle for holding a transparent or semi-transparent aqueous composition comprising: transparent walls having a front portion and a rear portion; a first label extending over a substantial extent of the surface of the front portion; the first label having an inwardly and outwardly directed surface; the inwardly directed surface engaging an opposed surface of the bottle; wherein the surface area of the first label is more than 25% transparent or translucent; a second label extending over a substantial extent of the surface of the rear portion; the second label having an inwardly and outwardly directed surface; the inwardly directed surface engaging an opposed surface of the bottle; wherein the second label is opaque; wherein the inwardly directed surface of the second label contains a dark colored border covering greater than 90% of the circumference of the second label inwardly directed surface and inwardly directed surface of the second label has a light-colored interior portion; wherein there is gradual fading between the dark colored border and the light-colored interior portion; wherein width of the border less than 20% of the maximum width of the second label; and wherein the inwardly directed surface of the second label is devoid of indicia.

According to another embodiment of the present invention, the invention provides a bottle for holding a transparent or semi-transparent aqueous composition comprising: transparent walls having a front portion and a rear portion; a first label extending over a substantial extent of the surface of the front portion; the first label having an inwardly and outwardly directed surface; the inwardly directed surface engaging an opposed surface of the bottle; wherein the first label is substantially transparent; a second label extending over a substantial extent of the surface of the rear portion; the second label having an inwardly and outwardly directed surface; the inwardly directed surface engaging an opposed surface of the bottle; wherein the second label is substantially opaque; and wherein the inwardly directed surface of the second label contains a dark colored border covering greater than 50% of the circumference of the second label inwardly directed surface and the inwardly directed surface of the second label has a substantially light-colored interior portion.

According to another embodiment of the present invention, the invention provides a label assembly comprising: a front label and a rear label both affixed to a non-opaque bottle, the front label having a transparent portion and the rear label having an opaque portion, wherein the bottle facing side of the rear label has a solid colored border with a white interior portion.

It is to be understood that both the foregoing general description and the following detailed description are exemplary and are intended to provide further explanation of the invention claimed. The accompanying drawings, which are incorporated in and constitute part of this specification, are included to illustrate and provide a further understanding of the invention. Together with the description, the drawings serve to explain various aspects of the invention.

### BRIEF DESCRIPTION OF THE DRAWINGS

For a more complete understanding of the present invention, the objects and advantages thereof, reference is now made to the following descriptions taken in connection with the accompanying drawings:

FIG. 1 is a front view of a front label.

FIG. 2 is a front view of a rear label.

FIG. 3 is a front perspective view of a bottle having both a front and a rear label.

### DETAILED DESCRIPTION OF PREFERRED EMBODIMENTS

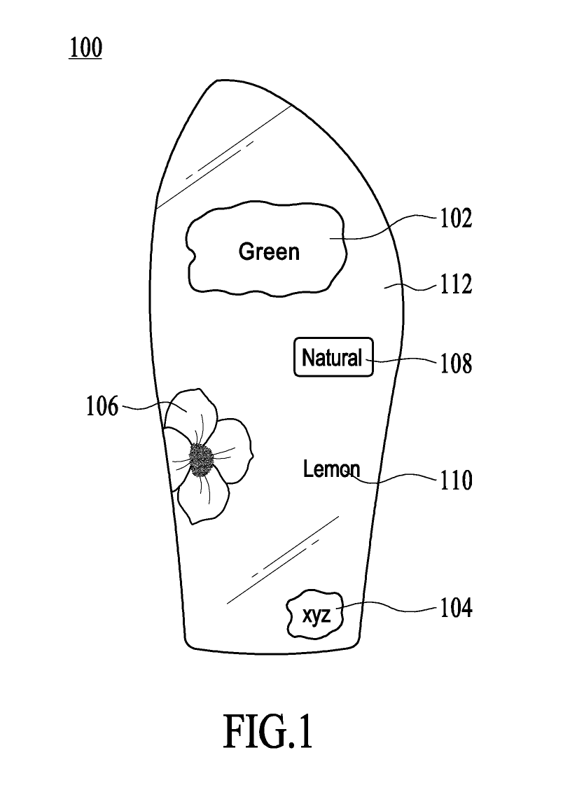

Representative embodiments of the present invention and their advantages may be understood by referring to FIGS. 1-3, wherein like reference numerals refer to like elements.

The bottle has a front surface and a rear surface opposite the front surface. The front label is attached to the front surface of the bottle with an outwardly directed surface facing away from the bottle and an inwardly directed surface attached to the bottle front surface. The rear label is attached to the rear surface of the bottle with an outwardly directed surface facing away from the bottle and an inwardly directed surface attached to the bottle rear surface. Referring now to FIG. 1, the front label outwardly directed surface 100 shows an opaque primary branding 102, an opaque secondary branding 104, an opaque brand identification symbol 106, an opaque primary product descriptor 108, and an opaque secondary product descriptor 110 wherein the remaining label area 112 is transparent or translucent.

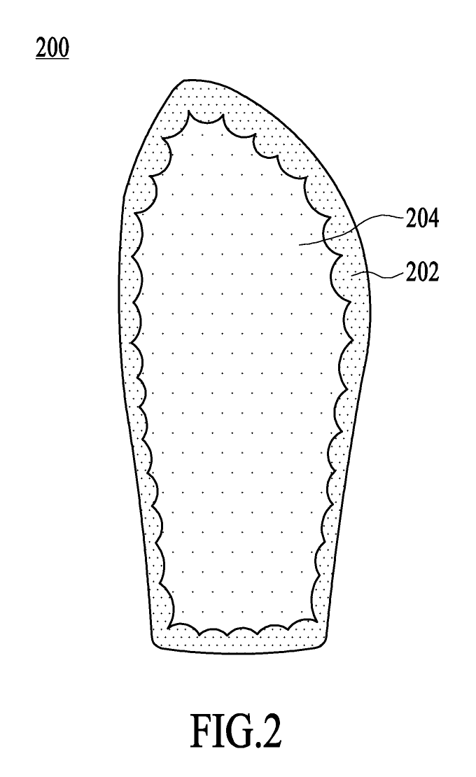

Referring now to FIG. 2, the rear label inwardly directed surface 200 shows an opaque dark-colored border 202 and an opaque light-colored interior portion 204.

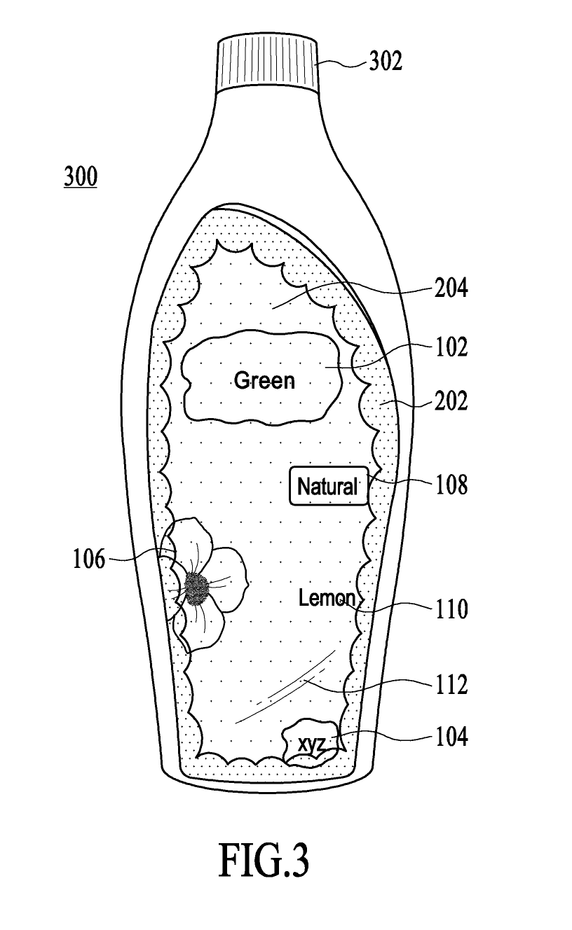

Referring now to FIG. 3, the bottle 300 has a front transparent or translucent label outwardly directed surface 100 with the rear opaque label inwardly directed surface 200 showing through with the opaque dark-colored border 202 and the light-colored interior portion 204. The bottle has transparent walls having a front portion and a rear portion and typically holds a transparent or semi-transparent aqueous composition, such as a cleaning composition, that can be clear or colored. A bottle with this labeling assembly is particularly useful for containing an LDL or dishwashing liquid. The bottle can have a squeeze cap dispenser 302 or a trigger sprayer (not shown) as described in U.S. Pat. No. 5,794,822 to Foster, or a pump dispenser (not shown) as described in U.S. Pat. App. 20040229963 to Stephane Sylvain Culeron et al., all or which are hereby incorporated herein.

The front label 100 extends over a substantial extent of the surface of the front portion of the bottle 300 and has an inwardly and outwardly directed surface. The inwardly directed surface engages an opposed surface of the bottle and the surface area of the first label is typically more than 25% transparent or translucent, or more than 40% transparent or translucent, or more than 50% transparent or translucent, or more than 80% transparent or translucent.

The rear label 200 extends over a substantial extent of the surface of the rear portion of the bottle 300 and has an inwardly and outwardly directed surface. The inwardly directed surface engages an opposed surface of the bottle and the rear label is typically opaque. The inwardly directed surface of the rear label 200 contains a dark colored border 202 covering greater than 50% (or greater than 70% or greater than 90%, or 100%) of the circumference of the rear label inwardly directed surface and the inwardly directed surface of the rear label 200 has a light-colored interior portion 204. The light-colored interior portion 204 is typically white to contrast with the darker border 202. There can be a gradual fading between the dark-colored border 202 and the light-colored interior portion 204, or there can be an immediate change. The dark-colored border 202 can be a simple stripe or it can have a scalloped appearance as in FIG. 2.

The width of the border 202 can be less than 20% of the maximum width of the second label, or less than 10%, or less than 30%. The important thing is that it provide a framing burst to the front label. The inwardly directed surface of the rear label 200 is typically devoid of indicia, while the outwardly directed surface of the rear label typically has multiple indicia, such as directions for use, ingredients, and safety information.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A bottle for holding a transparent or semi-transparent aqueous composition comprising:
a. transparent walls having a front portion and a rear portion;
b. a first label extending over a substantial extent of the surface of the front portion; the first label having an inwardly and outwardly directed surface; the inwardly directed surface engaging an opposed surface of the bottle; wherein the surface area of the first label is more than 25% transparent or translucent;
c. a second label extending over a substantial extent of the surface of the rear portion; the second label having an inwardly and outwardly directed surface; the inwardly directed surface engaging an opposed surface of the bottle; wherein the second label is opaque;
d. wherein the inwardly directed surface of the second label contains a dark colored border covering greater than 90% of the circumference of the second label inwardly directed surface and inwardly directed surface of the second label has a light-colored interior portion;
e. wherein there is gradual fading between the dark colored border and the light-colored interior portion;
f. wherein width of the border less than 20% of the maximum width of the second label; and
g. wherein the inwardly directed surface of the second label is devoid of indicia.

2. A bottle for holding a transparent or semi-transparent aqueous composition comprising:
a. transparent walls having a front portion and a rear portion;
b. a first label extending over a substantial extent of the surface of the front portion; the first label having an inwardly and outwardly directed surface; the inwardly directed surface engaging an opposed surface of the bottle; wherein the first label is substantially transparent;
c. a second label extending over a substantial extent of the surface of the rear portion; the second label having an inwardly and outwardly directed surface; the inwardly directed surface engaging an opposed surface of the bottle; wherein the second label is substantially opaque; and
d. wherein the inwardly directed surface of the second label contains a dark colored border covering greater than 50% of the circumference of the second label inwardly directed surface and the inwardly directed surface of the second label has a substantially light-colored interior portion.

3. The bottle of claim 2, wherein the dark colored border of the inwardly directed surface of the second label covers greater than 90% of the circumference of the second label inwardly directed surface.

4. The bottle of claim 2, wherein the interior portion of the inwardly directed surface of the second label is white.

5. The bottle of claim 2, wherein the inwardly directed surface of the second label is devoid of indicia.

6. The bottle of claim 2, wherein the outwardly directed surface of the second label carries indicia.

7. The bottle of claim 2, wherein there is gradual fading between the dark-colored border and the light-colored interior portion.

8. The bottle of claim 2, wherein there is an immediate change between the dark-colored border and the light-colored interior portion.

9. The bottle of claim 2, wherein width of the border less than 20% of the maximum width of the second label.

10. The bottle of claim 2, wherein width of the border less than 20% of the maximum width of the second label.

11. The bottle of claim 2, wherein width of the border less than 30% of the maximum width of the second label.

12. The bottle of claim 2, wherein width of the border less than 10% of the maximum width of the second label.

13. The bottle of claim 2, wherein the surface area of the first label is more than 25% transparent or translucent.

14. The bottle of claim 2, wherein the surface area of the first label is more than 40% transparent or translucent.

15. The bottle of claim 2, wherein the surface area of the first label is more than 50% transparent or translucent.

16. The bottle of claim 2, wherein the surface area of the first label is more than 80% transparent or translucent.

17. A label assembly comprising: a front label and a rear label both affixed to a non-opaque bottle, the front label having a transparent portion and the rear label having an opaque portion, wherein the bottle facing side of the rear label has a solid colored border with a white interior portion.

18. The label assembly of claim 17, wherein the bottle has a squeeze cap dispenser.

19. The label assembly of claim 17, wherein the bottle has a trigger sprayer dispenser.

20. The label assembly of claim 17, wherein the bottle has a pump dispenser.
